(19) United States
(12) Patent Application Publication
(10) Pub. No.: US 2006/0268482 A1
(43) Pub. Date: Nov. 30, 2006

(54) Equipment management methods and systems

(75) Inventors: Jung-Cheng Lin, Hsinchu City (TW); Zen-Jay Lin, Taoyuan County (TW); Chia-Shun Lai, Hsinchu County (TW); Lien Chen, Hsinchu City (TW); Zhi-Yue Ke, Taipei County (TW)

Correspondence Address: QUINTERO LAW OFFICE, 1617 BROADWAY, 3RD FLOOR, SANTA MONICA, CA, 90404, US

(73) Assignee: INDUSTRIAL TECHNOLOGY RESEARCH INSTITUTE, HSINCHU (TW)

(21) Appl. No.: 11/266,947

(22) Filed: Nov. 3, 2005

(30) Foreign Application Priority Data
May 31, 2005 (TW) TW94117793

(51) Int. Cl. H02H 3/00

(52) U.S. Cl. 361/62

(57) ABSTRACT

An equipment management system. A detector detects at least one protector in a detection field thereof utilizing wireless communication techniques. A database stores an equipment rule for an area. The equipment rule comprises predetermined types of protectors and predetermined number for each type. A processor automatically determines if the equipment rule is satisfied by determining if the types of protectors actually detected in a period and the number of each detected type are equal to the predetermined types and numbers.

### BACKGROUND

The invention relates to computer communication techniques, and in particular, to equipment management methods and systems.

Personnel must be equipped with appropriate protectors before entering an environment where the risk of chemicals, falling objects, high-voltage power, radiation, or others exists. For example, chemical protection suits defend against chemicals; safety helmets against falling objects; isolating outfits against high-voltage power; and radiation detectors against radiation. Other protectors comprise safety glasses, isolating helmets, other protection suits, isolating shoes and gloves, and other detectors.

The personnel outfits are typically checked manually, thus consuming manpower and increasing the potential for faulty examination.

### SUMMARY

Accordingly, equipment management methods and systems are provided. An exemplary embodiment of an equipment management system comprises a detector, a database, and a processor coupled to the detector and the database. The detector detects at least one protector in a detection field thereof utilizing wireless communication techniques. The database stores an equipment rule for an area. The equipment rule comprises predetermined types of protectors and a predetermined number for each type. The processor automatically determines if the equipment rule is satisfied by determining if the types of protectors actually detected in a period and, the number of each detected type are equal to the predetermined types and numbers.

Another exemplary embodiment of an equipment management system comprises a detector, a database, and a processor coupled to the detector and the database. The detector detects at least one protector in a detection field thereof utilizing wireless communication techniques. The database stores an equipment rule for an area. The equipment rule comprises predetermined types of protectors and a predetermined relationship between the required number of each type. The processor automatically determines if the equipment rule is satisfied by determining if the types and number of protectors actually detected in a period match the predetermined types and relationships.

An exemplary embodiment of an equipment management method is provided. An equipment rule for an area is stored on a database. The equipment rule comprises predetermined types of protectors and a predetermined relationship between the required number of each type. At least one protector in a detection field is detected utilizing wireless communication techniques. Whether the equipment rule is satisfied is automatically determined based on if the types and number of protectors actually detected in a period match the predetermined types and relationships.

### DESCRIPTION OF THE DRAWINGS

The invention can be more fully understood by reading the subsequent detailed description and examples with references made to the accompanying drawings, wherein:

FIG. 1 is a block diagram of an exemplary embodiment of an equipment management system.

FIG. 2 is an example of an equipment rule.

FIG. 3 is an example of another equipment rule.

FIG. 4 is a flowchart of the operation of an exemplary embodiment of an equipment management system.

FIG. 5 is a schematic diagram an exemplary alert message on a display.

FIG. 6 is a block diagram of another exemplary embodiment of an equipment management system.

### DETAILED DESCRIPTION

Exemplary embodiments of the equipment management methods and systems are provided in the following.

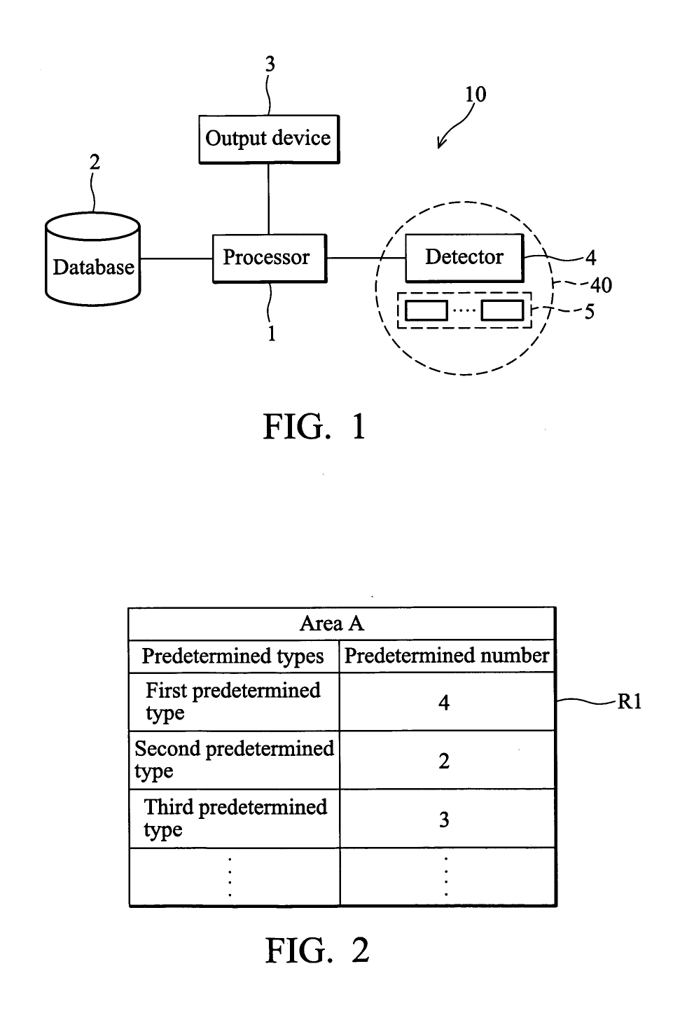

Equipment management system 10 in FIG. 1 comprises processor 1, database 2, output device 3, and detector 4. Detector 4 detects protectors of equipment group 5 for protector types in its reader field 40 (or read range) utilizing wireless communication techniques. Examples of protectors may comprise protection gloves, safety glasses, safety helmets, masks, respirators, protection suits, earmuffs, gas detectors, and radiation detectors. Safety glasses may comprise UV absorber safety glasses or safety goggles against chemicals. Safety helmets may comprise safety helmets with masks or respirators. Masks may comprise masks for medical use and those against acids or organic gases. Respirators may comprise those protecting against organic, acid, and ammonia gases, and vapors. Protection suits may comprise those protecting against fire, chemicals, vapors, acids and alkalis.

The detector may comprise a Radio Frequency Identification (RFID) reader. Each of the protectors may be attached with a RFID tag for type identification.

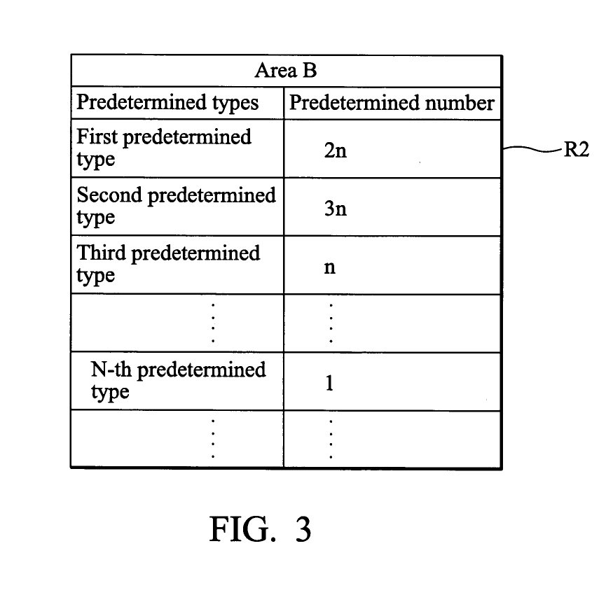

Database 2 stores schedules and equipment rules for respective areas. The schedule comprises correspondence between an area and the equipment rules (and other rules such as personnel management rules) with respect to work hours associated with the area. An equipment rule comprises predetermined types of protectors and a predetermined number for each type or a predetermined relationship between the required number of each type. FIG. 2 and FIG. 3 are different examples of equipment rules stored in database 2.

In FIG. 2, equipment rule R1 corresponding to area A comprises predetermined types of protectors and predetermined number for each type. Note that area A may correspond to more equipment rules with respect to a schedule. In FIG. 3, equipment rule R2 corresponding to area B comprises predetermined types of protectors, a predetermined number, and a predetermined relationship between the required number of each type. Specifically, in equipment rule R1, the predetermined numbers of the first type to the third type are respectively 4, 2, and 3. In equipment rule R2, the predetermined number of the N-th type is one; the formulas of the predetermined numbers of the first type to the third type are respectively 2n, 3n, and n. The n is a variable pertaining to an integer. Thus, equipment rule R2 indicates the proportion of the predetermined numbers of the first type to the third type. Note that equipment rules may be composed in other formats, and the formulas may be other functions of n.

Areas A and B may have names and be assigned to detector 4, representing real locations or reader fields. Equipment management system 10 may provide a user interface for assignment of detector 4 to an area. Database 2 may store information for the assignment. Note that database 2 may comprise one or more databases and be implemented in a memory or a storage device.

Database 2 may store protector types, identification codes thereof, and other relevant information, such as attributes of usage.

Detector 4 may be located at the entrance of an area to detect outfits of passing people, thus controlling access to dangerous areas, such as a chemical storeroom, areas under the threat of falling objects, high-voltage power, radiation, noise, vapors, high or low temperature, and pernicious gases, and isolation hospitals. Detector 4 may couple to an input device which, when triggered, begins a detection period of detector 4. Detector 4 may utilize multitasking techniques, such as time division multiple access (TDMA), to simultaneously detect types of protectors in reader field 40. Many solutions have be developed to implement multiple access schemes in RFID systems.

Equipment management system 10 may comprise other device, such as a clock, a speaker, a display, or a gate device. The clock provides a current time. The speaker and the display output appropriate alerts.

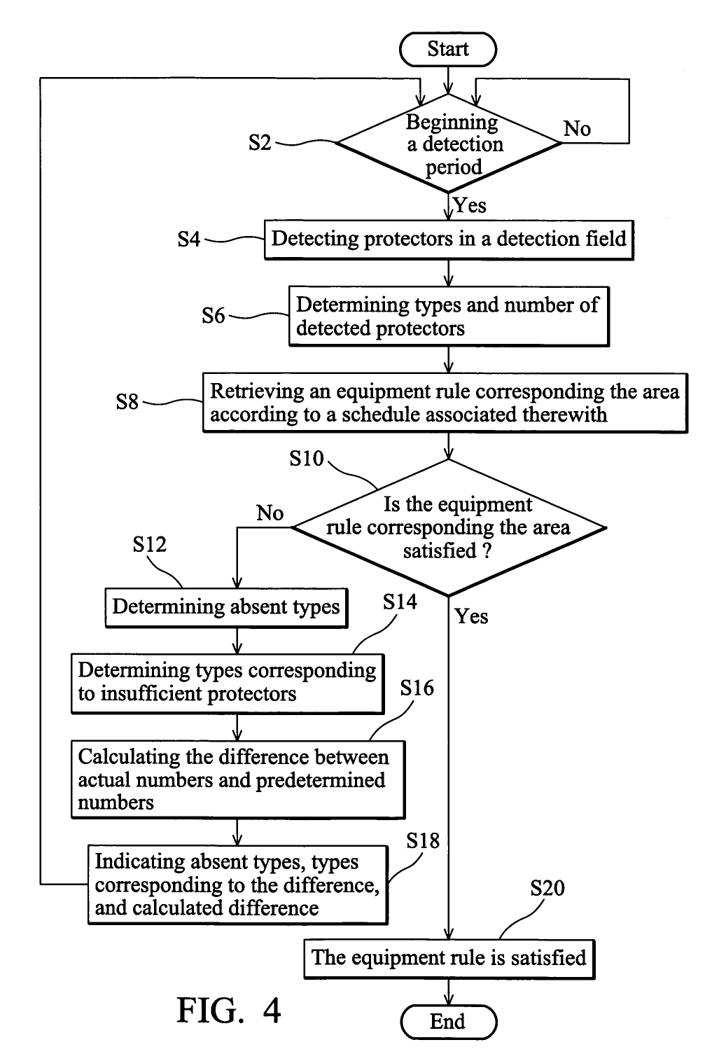

With reference to FIG. 4, when detector 4 detects a protector, a detection period begins (step S2). During the detection period, detector 4 detects all protectors in its reader field 40 during the detection period (step S4), and processor 1 determines the type of detected protectors and the actual number of each protector type (step S6). For example, processor 1 determines the type of each protector by an identification code thereof included in RFID tag attached thereto. Next, if an area is assigned to detector 4, processor 1 retrieves an equipment rule corresponding to the area from database 2 according to present time and a schedule of the area (step S8). Processor 1 automatically determines if the types of protectors and the number of each type actually detected by detector 4 in the detection period both satisfy the equipment rule corresponding to the area (step S10).

For example, if area A has been assigned to detector 4, and equipment group 5 exists in reader field 40, processor 1 automatically determines if protector types of equipment group 5 and the number of each type actually detected by detector 4 in the detection period both satisfy equipment rule R1. In other words, when each predetermined type in equipment rule R1 has at least one substantial protector detected by detector 4, and the predetermined number of each predetermined type is equal to actual number of the corresponding detected protectors, processor 1 determines that equipment group 5 satisfies equipment rule R1 (step S20).

Output device 3 outputs appropriate signals according to the result of step S10. For example, output device 3 may output control signals to switch a gate or other electronic device, thus controlling access to area A. Processor 1 may record data of person entering area A, such as the entrance time, and any equipment carried therewith. Processor 1 may combine other factors, such as schedules stored in database 2, when determining whether to open area A.

If not, processor 1 determines which predetermined type lacks substantial protector (step S12), i.e. absent types, and which predetermined type has less substantial protectors corresponding thereto than the predetermined number thereof, i.e. predetermined types corresponding to insufficient protectors, with reference to equipment rule R1 (step S14). Processor 1 calculates the difference between the actual number and the predetermined number of each predetermined type corresponding to insufficient protectors (step S16).

If area B is assigned to detector 4, processor 1 retrieves equipment rule R2 corresponding to area B from database 2 and performs the previously-described steps. Note that, in step S14, processor 1 calculates the predetermined number of each type utilizing the predetermined number formulas in equipment rule R2 and actual number detected by detector 4, and subsequently determines predetermined types corresponding to insufficient protectors. For example, processor 1 may determine a maximum actual number P and a corresponding predetermined number formula f(n) thereof and calculate n according to the following equitation:
P=f(n) (1)

If the calculated value of n is not an integer, processor 1 determines that the second largest number is actually detected, retrieves a corresponding predetermined number formula thereof, and repeats the calculation to retrieve an integer n. Processor 1 then derives the predetermined number of each predetermined type utilizing the calculated integer n, and accordingly determines predetermined types having insufficient protectors.

For example, processor 1 locates a maximum actual number “5”, the corresponding third predetermined type, and a corresponding predetermined number formula 3n thereof. Processor 1 accordingly calculates the value of n, which is not an integer. Hence, processor 1 determines a second largest number “4” is actually detected, retrieves a corresponding predetermined number formula 2n, the parameter of which is less than that of 3n, and retrieves n=2. Thus, processor 1 can derive the predetermined number of each predetermined type.

Output device 3 provides alerts to indicate the absent types, the predetermined types corresponding to insufficient protectors, the differences between actual numbers and predetermined numbers, and other relative information, such as actual numbers and predetermined numbers (step S18). The provided alerts may be audio signals or image signals of which audio and images may be stored in database 2 in advance.

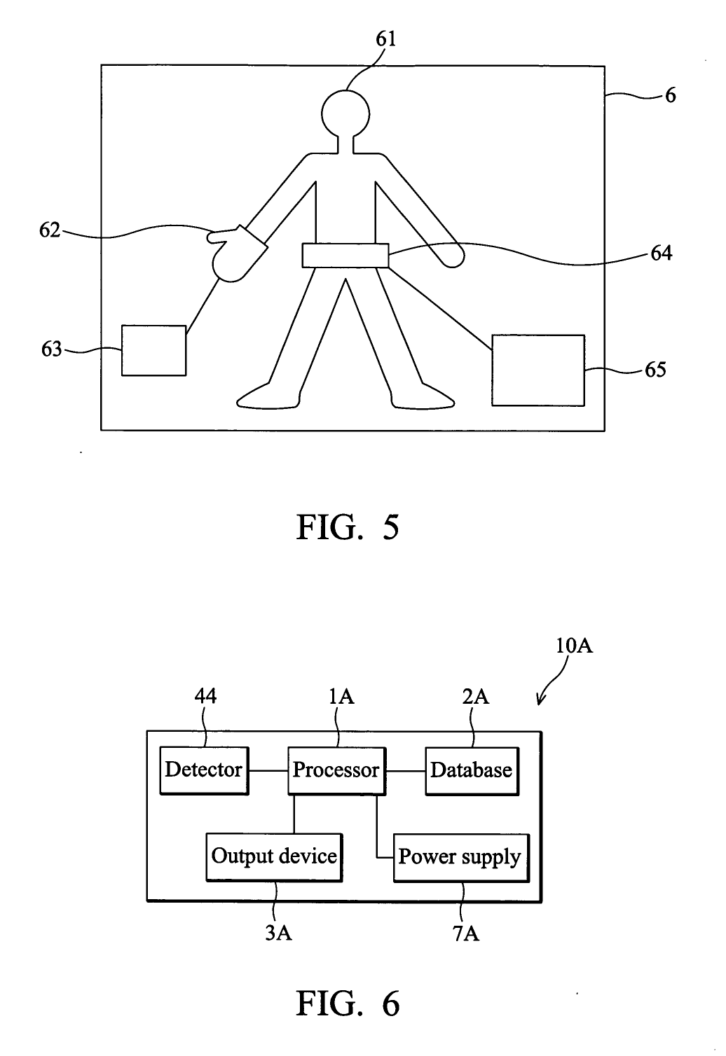

With reference to FIG. 5, output device 6 comprises display 6. Database 2 may further store an image 61 of a person and the predetermined location of each predetermined type corresponding to a location relative to image 61. In step S18, display 6 may show image 61 and indicate the absent types and types corresponding to insufficient protectors relative to image 61 according to predetermined locations thereof. When glove 62 pertains to the absent types, and belt 64 pertains to the predetermined types corresponding to insufficient protectors, display 6 shows glove 62 and belt 64 relative to image 61 according to predetermined locations thereof and displays corresponding message 63 and 65. Message 63 may comprise the type, identification code, predetermined number, and actual number of glove 62. Message 65 may comprise the type, identification code, predetermined number, actual number, and the difference therebetween of belt 64.

Equipment management systems are not limited to those previously described embodiment. Processor 1 may couple to more detectors. Processor 1, database 2, and detector 4 may couple to each other by wired or wireless networks (such as local area networks).

With reference to FIG. 6, equipment management system 10A comprises a portable device with stand-alone power supply 7A. Power supply 7A provides electrical power to processor 1A, database 2A, output device 3A, and detector 4A to perform the previously-described steps.

Thus, wireless communication techniques are utilized to detect and identify the types and number of protectors, and appropriate alerts are accordingly provided.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An equipment management system, comprising:
a detector detecting at least one protector in a detection field thereof utilizing wireless communication techniques;
a database storing an equipment rule for an area, wherein the equipment rule comprises a plurality of predetermined types of protectors and a predetermined number for each type; and
a processor coupled to the detector and the database, automatically determining if the equipment rule is satisfied by determining if the types of protectors actually detected by the detector in a period and the number of each detected type are equal to the predetermined types and numbers.

2. The equipment management system as claimed in claim 1, wherein the detector comprises a Radio Frequency Identification (RFID) reader, and each of the protectors is attached with a RFID tag.

3. The equipment management system as claimed in claim 1, further comprising:
an output device, when the equipment rule is not satisfied after the period, providing an alert indicating a first predetermined type has not been detected by the detector.

4. The equipment management system as claimed in claim 3, wherein when the number actually detected of a second predetermined type is not equal to the predetermined number thereof, the output device indicates the difference therebetween or the predetermined number of the second predetermined type.

5. The equipment management system as claimed in claim 4, wherein the alert comprises an image.

6. The equipment management system as claimed in claim 4, wherein the database further stores an image of a simulated person and a predetermined location corresponding to the first predetermined type, further comprising:
a display showing the image of a simulated person and indicating the first predetermined type relative to the image of a simulated person according to the predetermined location.

7. The equipment management system as claimed in claim 1, wherein the equipment management system is a portable device with a stand-alone power supply.

8. The equipment management system as claimed in claim 1, wherein the detector simultaneously detects the protectors by utilizing time division multiple access (TDMA) techniques.

9. The equipment management system as claimed in claim 1, wherein the database further stores equipment rules and a schedule corresponding to the area, the schedule comprises correspondence between the area and the equipment rules with respect to work hours associated with the area, the processor further retrieves the equipment rule according to the schedule.

10. An equipment management system, comprising:
a detector detecting at least one protector in a detection field thereof utilizing wireless communication techniques;
a database storing an equipment rule for an area, wherein the equipment rule comprises predetermined types of protectors and a predetermined relationship between the required number of each type; and
a processor coupled to the detector and the database, automatically determining if the equipment rule is satisfied by determining if the types and number of protectors actually detected by the detector in a period match the predetermined types and relationship.

11. The equipment management system as claimed in claim 10, wherein the detector comprises a Radio Frequency Identification (RFID) reader, and each of the protectors is attached with a RFID tag.

12. The equipment management system as claimed in claim 10, wherein the predetermined relationship comprises a proportion of the respective required number of each predetermined type.

13. The equipment management system as claimed in claim 12, wherein the processor calculates a predetermined number of each type utilizing the predetermined relationship and the actual number of a first type detected by the detector.

14. The equipment management system as claimed in claim 13, further comprising:
an output device, when the actual number of a second predetermined type is not equal to the predetermined number thereof, indicating the difference therebetween or the predetermined number of the second predetermined type.

15. The equipment management system as claimed in claim 14, wherein the database further stores an image of a simulated person and a predetermined location corresponding to the second predetermined type, further comprising:
a display showing the image of a simulated person and indicating the second predetermined type relative to the image of a simulated person according to the predetermined location.

16. The equipment management system as claimed in claim 11, wherein the equipment management system is a portable device with a stand-alone power supply.

17. The equipment management system as claimed in claim 11, wherein the detector simultaneously detects the protectors by utilizing time division multiple access (TDMA) techniques.

18. The equipment management system as claimed in claim 11, wherein the database further stores equipment rules and a schedule corresponding to the area, the schedule comprises correspondence between the area and the equipment rules with respect to work hours associated with the area, the processor further retrieves the equipment rule according to the schedule.

19. An equipment management method, comprising:
storing an equipment rule for an area on a database, wherein the equipment rule comprises predetermined types of protectors and a predetermined relationship between the required number of each type; and
automatically determining if the equipment rule is satisfied by determining if the types and number of protectors actually detected in a detection field utilizing wireless communication techniques in a period match the predetermined types and relationship.

20. The equipment management method as claimed in claim 19, wherein the predetermined relationship comprises a proportion of the respective required number of each predetermined type.
